(19) United States
(12) Patent Application Publication
(10) Pub. No.: US 2025/0271935 A1
(43) Pub. Date: Aug. 28, 2025

(54) HAPTICS EFFECT COMPRISING A WASHOUT

(71) Applicant: InterDigital CE Patent Holdings, SAS, Paris (FR)

(72) Inventors: Fabien Danieau, Rennes (FR); Quentin Galvane, Thorigne-Fouillard (FR); Philippe Guillotel, Vern sur Seiche (FR)

(21) Appl. No.: 18/858,188

(22) PCT Filed: Apr. 6, 2023
(86) PCT No.: PCT/EP2023/059239

§ 371 Date: Oct. 18, 2024

(30) Foreign Application Priority Data
Apr. 22, 2022 (EP) 22305605.2
Jan. 10, 2023 (EP) 23305029.3

(51) Int. Cl. G06F 3/01

(52) U.S. Cl. CPC G06F 3/016; G06F 3/011

(57) ABSTRACT

Syntax elements of a haptic scene format distinguish, for a haptic signal, the parts of the haptic signal related to the haptic effect from the parts related to the washout. This allows a haptic rendering device to adapt the haptic signal to the specific type of haptic device, the haptic device capabilities and the target body part, in order to remain below the perception threshold and ensure the expected haptic experience.

### TECHNICAL FIELD

At least one of the present embodiments generally relates to haptics and more particularly to a syntax describing a haptic effect comprising haptic washout information, a method and device for rendering the haptic effect.

### BACKGROUND

Fully immersive user experiences are proposed to users through immersive systems based on feedback and interactions. The interaction may use conventional ways of control that fulfill the need of the users. Current visual and auditory feedback provide satisfying levels of realistic immersion. Additional feedback can be provided by haptic effects that allow a human user to perceive a virtual environment with his senses and thus get a better experience of the full immersion with improved realism. However, haptics is still one area of potential progress to improve the overall user experience in an immersive system.

Conventionally, an immersive system may comprise a 3D scene representing a virtual environment with virtual objects localized within the 3D scene. To improve the user interaction with the elements of the virtual environment, haptic feedback may be used through stimulation of haptic actuators. Such interaction is based on the notion of “haptic objects” that correspond to physical phenomena to be transmitted to the user. In the context of an immersive scene, a haptic object allows to provide a haptic effect by defining the stimulation of appropriate haptic actuators to mimic the physical phenomenon on the haptic rendering device. Different types of haptic actuators allow to restitute different types of haptic feedbacks.

An example of a haptic object is an explosion. An explosion can be rendered though vibrations and heat, thus combining different haptic effects on the user to improve the realism. An immersive scene typically comprises multiple haptic objects, for example using a first haptic object related to a global effect and a second haptic object related to a local effect.

The principles described herein apply to any immersive environment using haptics such as augmented reality, virtual reality, mixed reality, or haptics-enhanced video (or omnidirectional/360° video) rendering, for example, and more generally apply to any haptics-based user experience. A scene for such examples of immersive environments is thus considered an immersive scene.

Haptics refers to sense of touch and includes two dimensions, tactile and kinesthetic. The first one relates to tactile sensations such as friction, roughness, hardness, temperature and is felt through the mechanoreceptors of the skin (Merkel cell, Ruffini ending, Meissner corpuscle, Pacinian corpuscle). The second one is linked to the sensation of force/torque, position, motion/velocity provided by the muscles, tendons and the mechanoreceptors in the joints. Haptics is also involved in the perception of self-motion since it contributes to the proprioceptive system (i.e., perception of one's own body). Thus, the perception of acceleration, speed or any body model could be assimilated as a haptic effect. The frequency range is about 0 to 1 kHz depending on the type of modality. Most existing devices able to render haptic signals generate vibrations. Examples of such haptic actuators are linear resonant actuator (LRA), eccentric rotating mass (ERM), and voice-coil linear motor. These actuators may be integrated into haptic rendering devices such as haptic suits but also smartphones or game controllers.

To encode haptic signals, several formats have been defined related to either a high-level description using XML-like formats (for example MPEG-V), parametric representation using json-like formats such as Apple Haptic Audio Pattern (AHAP) or Immersion Corporation's HAPT format, or waveform encoding (IEEE 1918.1.1 ongoing standardization for tactile and kinesthetic signals). The HAPT format has been recently included into the MPEG ISOBMFF file format specification (ISO/IEC 14496 part 12). Moreover, GL Transmission Format (glTF™) is a royalty-free specification for the efficient transmission and loading of 3D scenes and models by applications. This format defines an extensible, common publishing format for 3D content tools and services that streamlines authoring workflows and enables interoperable use of content across the industry.

Moreover, a new haptic file format is being defined within the MPEG standardization group and relates to a coded representation for haptics. The Reference Model of this format is not yet released but is referenced herein as RM0. With this reference model, the encoded haptic description file can be exported either as a JSON interchange format (for example a .gmpg file) that is human readable or as a compressed binary distribution format (for example a .mpg) that is particularly adapted for transmission towards haptic rendering devices.

In the domain of haptic rendering, a major issue is related to the physical limitations associated with the rendering devices. Indeed, for a rendering device supposed to provide heat sensation to the user, for example to be associated with an explosion in an action movie, there is some inertia to deliver the heat and then to cool again. As a consequence, in some cases it is not possible to combine the succession of some haptic effects. In the case of a haptic device, when two “forward acceleration” effects need to be rendered, the haptic device may not have enough movement range to combine the two required movements. To overcome this issue, the haptic device will first move forward to deliver the acceleration feeling, then it will have to go back to its original position before moving forward again to deliver the second acceleration. This intermediary step of moving back to the original position between two effects is called “washout” and should not be perceived by the user. In order to be unnoticed by the user, the acceleration of the movement must be smaller than the threshold of the vestibular system which is around 0.1 m/s².

### SUMMARY

Embodiments are at least related to syntax elements of a haptic scene format allowing to differentiate, within a haptic signal, the part related to the washout from the part related to the normal haptic effect. This allows a haptic rendering device to adapt the haptic signal to the specific type of haptic device, the haptic device capabilities, and the target body part, in order to remain below the perception threshold and ensure the expected haptic experience.

A first aspect of at least one embodiment is directed to a method comprising obtaining haptic data representative of a haptic feedback, the haptic data comprising a haptic signal to render the haptic feedback and information representative of a washout, when the information representative of a washout indicates that the haptic signal is a washout effect, adapting the haptic signal to remain below a perception threshold, and providing the adapted haptic signal.

A second aspect of at least one embodiment is directed to a device comprising a processor configured to obtain haptic data for haptic feedback, the haptic data comprising a haptic signal to render the haptic feedback and information representative of a washout, when the information representative of a washout indicates that the haptic signal is a washout effect, adapt the haptic signal to remain below a perception threshold, and provide the adapted haptic signal for rendering.

A third aspect of at least one embodiment is directed to a method comprising encoding haptic data representative of a haptic feedback, the haptic data comprising a haptic signal and information representative of a washout effect indicating that the haptic signal is a washout effect and providing the encoded haptic data.

A fourth aspect of at least one embodiment is directed to a device comprising a processor configured to encode haptic data representative of a haptic feedback, the haptic data comprising a haptic signal and information representative of a washout effect indicating that the haptic signal is a washout effect and provide the encoded haptic data.

According to a fifth aspect of at least one embodiment, a computer program comprising program code instructions executable by a processor is presented, the computer program implementing at least the steps of a method according to the first aspect.

According to a sixth aspect of at least one embodiment, a computer program product which is stored on a non-transitory computer readable medium and comprises program code instructions executable by a processor is presented, the computer program product implementing at least the steps of a method according to the first aspect.

A seventh aspect of at least one embodiment is directed to a data structure comprising haptic data for a haptic feedback, the haptic data comprising a haptic signal and information representative of a washout indicating that the haptic signal is a washout effect, the haptic data being generated according to the third aspect.

An eighth aspect of at least one embodiment is directed to a non-transitory computer readable medium comprising haptic data for a haptic feedback, the haptic data comprising a haptic signal and information representative of a washout indicating that the haptic signal is a washout effect, the haptic data being generated according to the third aspect.

In embodiments of these aspects, the information representative of a washout effect is represented by a Boolean flag or an enumerated value. In embodiments of these aspects, the information representative of a washout effect is represented using a JSON syntax based on glTF™ specification.

### BRIEF DESCRIPTION OF THE DRAWINGS

FIG. 1 illustrates a block diagram of an example of a system in which various aspects and embodiments are implemented.

FIG. 2 illustrates an example of structure for describing an immersive scene according to one embodiment.

FIG. 3 illustrates an example of structure for the interchange file format describing an immersive scene.

FIG. 4 illustrates an example of signal coded using two haptic bands.

FIG. 5 illustrates the conventional method for encoding a low-level haptic signal in two bands of frequencies.

FIG. 6A illustrates an example of haptic signal for a motion platform haptic device comprising three forwards effects.

FIG. 6B illustrates an example of the adaption of the haptic signal of FIG. 6A to a force feedback haptic device according to an embodiment.

FIG. 7 illustrates an example flowchart of process for rendering a haptic feedback description file according to embodiments.

FIG. 8A illustrates a second example of the adaptation of the haptic signal of FIG. 6A to a force feedback haptic device according to an embodiment.

FIG. 8B illustrates a third example of the adaptation of the haptic signal of FIG. 6A to a force feedback haptic device according to an embodiment.

### DETAILED DESCRIPTION

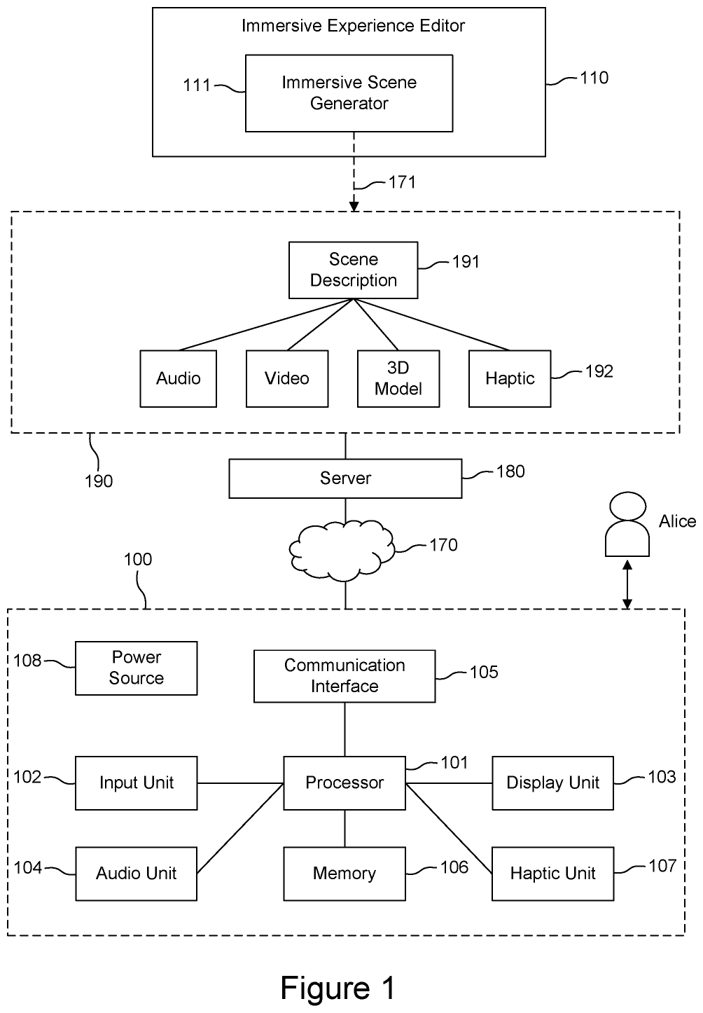

FIG. 1 illustrates a block diagram of an example of immersive system in which various aspects and embodiments are implemented. In the depicted immersive system, the user Alice uses the haptic rendering device 100 to interact with a server 180 hosting an immersive scene 190 through a communication network 170. This immersive scene 190 may comprise various data and/or files representing different elements (scene description 191, audio data, video data, 3D models, and haptic description file 192) required for its rendering. The immersive scene 190 may be generated under control of an immersive experience editor 110 that allows to arrange the different elements together and design an immersive experience. Appropriate description files and various data files representing the immersive experience are generated by an immersive scene generator 111 in a format adapted for transmission to haptic rendering devices. The immersive experience editor 110 is typically performed on a computer that will generate immersive scene to be hosted on the server. For the sake of simplicity, the immersive experience editor 110 is illustrated as being directly connected through the dotted line 171 to the immersive scene 190. In practice, the immersive scene 190 is hosted on the server 180 and the computer running the immersive experience editor 110 is connected to the server 180 through the communication network 170.

The haptic rendering device 100 comprises a processor 101. The processor 101 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform data processing such as haptic signal decoding, input/output processing, and/or any other functionality that enables the device to operate in an immersive system.

The processor 101 may be coupled to an input unit 102 configured to convey user interactions. Multiple types of inputs and modalities can be used for that purpose. Physical keypad or a touch sensitive surface are typical examples of input adapted to this usage although voice control could also be used. In addition, the input unit may also comprise a digital camera able to capture still pictures or video in two dimensions or a more complex sensor able to determine the depth information in addition to the picture or video and thus able to capture a complete 3D representation. The processor 101 may be coupled to a display unit 103 configured to output visual data to be displayed on a screen. Multiple types of displays can be used for that purpose such as a liquid crystal display (LCD) or organic light-emitting diode (OLED) display unit. The processor 101 may also be coupled to an audio unit 104 configured to render sound data to be converted into audio waves through an adapted transducer such as a loudspeaker for example. The processor 101 may be coupled to a communication interface 105 configured to exchange data with external devices. The communication preferably uses a wireless communication standard to provide mobility of the haptic rendering device, such as cellular (e.g., LTE) communications, Wi-Fi communications, and the like. The processor 101 may access information from, and store data in, the memory 106, that may comprise multiple types of memory including random access memory (RAM), read-only memory (ROM), a hard disk, a subscriber identity module (SIM) card, a memory stick, a secure digital (SD) memory card, any other type of memory storage device. In embodiments, the processor 101 may access information from, and store data in, memory that is not physically located on the device, such as on a server, a home computer, or another device.

The processor 101 is coupled to a haptic unit 107 configured to provide haptic feedback to the user, the haptic feedback being described in the haptic description file 192 that is related to the scene description 191 of an immersive scene 190. The haptic description file 192 describes the kind of feedback to be provided according to the syntax described further hereinafter. Such description file is typically conveyed from the server 180 to the haptic rendering device 100. The haptic unit 107 may comprise a single haptic actuator or a plurality of haptic actuators located at a plurality of positions on the haptic rendering device. Different haptic units may have a different number of actuators and/or the actuators may be positioned differently on the haptic rendering device.

In at least one embodiment, the processor 101 is configured to render a haptic signal according to embodiments described further below, in other words to apply a low-level signal to a haptic actuator to render the haptic effect. Such low-level signal may be represented using different forms, for example by metadata or parameters in the description file or by using a digital encoding of a sampled analog signal (e.g., PCM or LPCM).

The processor 101 may receive power from the power source 108 and may be configured to distribute and/or control the power to the other components in the device 100. The power source may be any suitable device for powering the device. As examples, the power source may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

While the figure depicts the processor 101 and the other elements 102 to 108 as separate components, it will be appreciated that these elements may be integrated together in an electronic package or chip. It will be appreciated that the haptic rendering device 100 may include any sub-combination of the elements described herein while remaining consistent with an embodiment. The processor 101 may further be coupled to other peripherals or units not depicted in FIG. 1 which may include one or more software and/or hardware modules that provide additional features, functionality and/or wired or wireless connectivity. For example, the peripherals may include sensors such as a universal serial bus (USB) port, a vibration device, a television transceiver, a hands-free headset, a Bluetooth® module, a frequency modulated (FM) radio unit, a digital music player, a media player, a video game player module, an Internet browser, and the like. For example, the processor 101 may be coupled to a localization unit configured to localize the haptic rendering device within its environment. The localization unit may integrate a GPS chipset providing longitude and latitude position regarding the current location of the haptic rendering device but also other motion sensors such as an accelerometer and/or an e-compass that provide localization services.

Typical examples of haptic rendering device 100 are haptic suits, smartphones, game controllers, haptic gloves, haptic chairs, haptic props, motion platforms, etc. However, any device or composition of devices that provides similar functionalities can be used as haptic rendering device 100 while still conforming with the principles of the disclosure.

In at least one embodiment, the device does not include a display unit but includes a haptic unit. In such embodiment, the device does not render the scene visually but only renders haptic effects. However, the device may prepare data for display so that another device, such as a screen, can perform the display. Example of such devices are haptic suits or motion platforms.

In at least one embodiment, the device does not include a haptic unit but includes a display unit. In such embodiment, the device does not render the haptic effect but only renders the scene visually. However, the device may prepare data for rendering the haptic effect so that another device, such as a haptic prop, can perform the haptic rendering. Examples of such devices are smartphones, head-mounted displays, or laptops.

In at least one embodiment, the device does not include a display unit nor does it include a haptic unit. In such embodiment, the device does not visually render the scene and does not render the haptic effects. However, the device may prepare data for display so that another device, such as a screen, can perform the display and may prepare data for rendering the haptic effect so that another device, such as a haptic prop, can perform the haptic rendering. Examples of such devices are computers, game consoles, optical media players, or set-top boxes.

In at least one embodiment, the immersive scene 190 and associated elements are directly hosted in memory 106 of the haptic rendering device 100 allowing local rendering and interactions. In a variant of this embodiment, the device 100 also comprises the immersive experience editor 110 allowing a fully standalone operation, for example without needing any communication network 170 and server 180.

Although the different elements of the immersive scene 190 are depicted in FIG. 1 as separate elements, the principles described herein apply also in the case where these elements are directly integrated in the scene description and not separate elements. Any mix between two alternatives is also possible, with some of the elements integrated in the scene description and other elements being separate files.

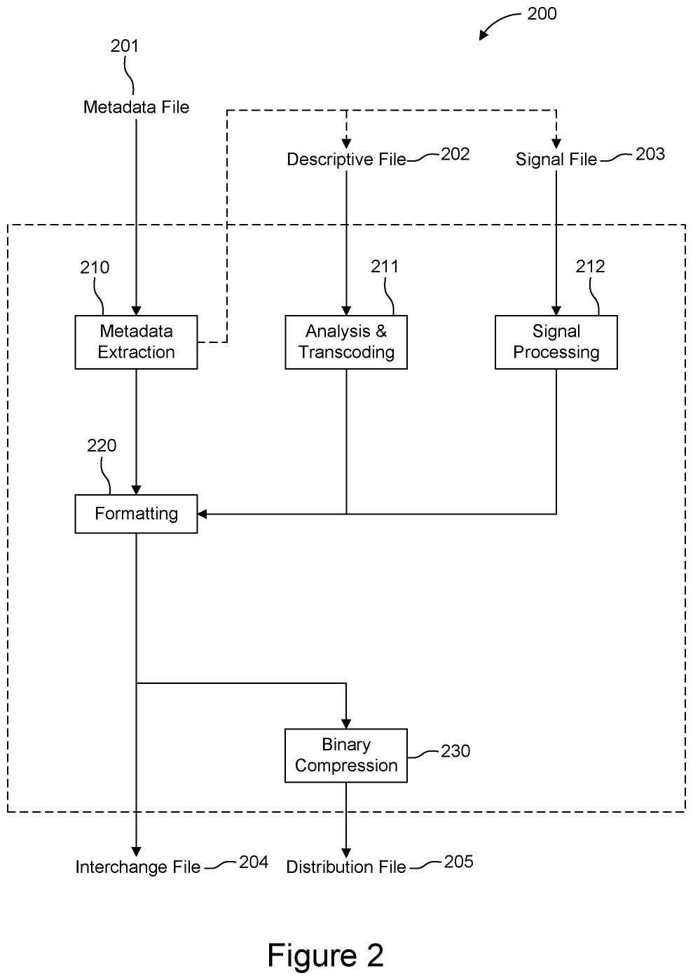

FIG. 2 illustrates an example of architecture for an encoder 200 for haptic files. This encoder 200 is for example implemented as a module of immersive scene generator 111 of an immersive editor 110 and typically performed on a computer generating the files describing the immersive scene. The inputs are a metadata file 201 and at least one low-level haptic signal file 203. The metadata file 201 is for example based on the ‘OHM’ haptic object file format. The signal files are representing analog signals to be applied to haptic actuators and are conventionally encoded using a pulse coded modulation (PCM) for example based on the WAV file format. The descriptive files 202 are for example based on the AHAP or HAPT file formats.

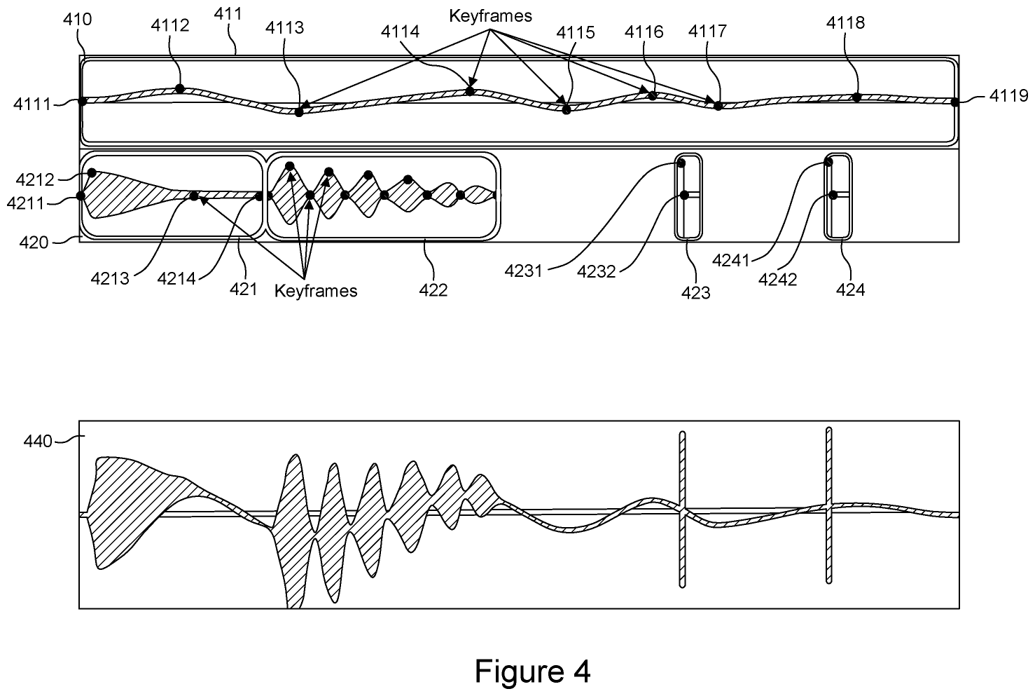

Metadata is extracted, in step 210, from the metadata file 201, allowing to identify the descriptive files and/or signal files. Descriptive files are analyzed and transcoded in step 211. In step 212, signal files are processed, for example, to decompose the signal in frequency bands and keyframes or wavelets, as further described in FIG. 4.

The formatting step 220 takes into account the transcoded and processed signals resulting of steps 211 and 212 to generate an interchange file 204 compliant with the data format according to one of the embodiments described herein. The interchange file 204 may be compressed in step 230 to be distributed in a transmission-friendly form such as the distribution file 205, more compact than the interchange file format but based on the same elements. Therefore, the interchange file format described herein is not strictly restricted to files but may also be used for broader transmission or distribution of the data (e.g., streaming, download).

The interchange file 204 can be a human readable file for example based on glTF™, XML or JSON formats. The distribution file 205 can be a binary encoded file for example based on MPEG file formats adapted for streaming or broadcasting to a decoder device.

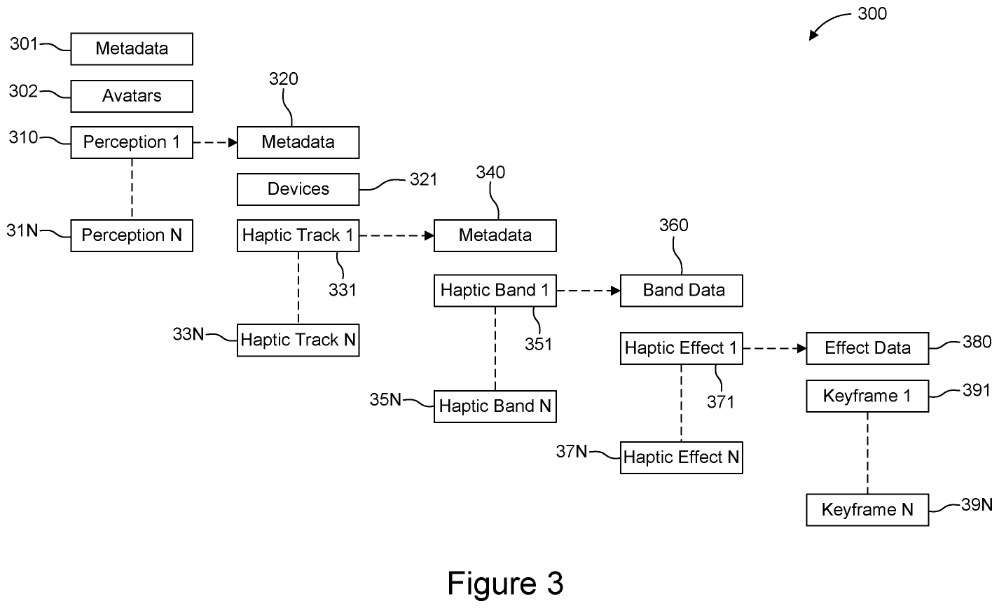

FIG. 3 illustrates an example of structure for the interchange file format describing an immersive scene. The data structure 300 represents the immersive scene 190. It can be decomposed in a set of layers. At the upper layer, metadata 301 describe high-level metadata information regarding the overall haptic experience defined in the data structure 300 and a list of avatars 302 (i.e., body representation) later referenced in the file. These avatars allow to specify a target location of haptic stimuli on the body. The haptic effects are described through a list of perceptions 310, 31N. These perceptions correspond to haptic signals associated with specific perception modalities such as vibration, force, position, velocity, temperature, etc.). A perception comprises metadata 320 to describe the haptic content of the signal, devices 321 to describe specifications of the haptic devices for which the signal was designed and a list of haptic tracks 331, 33N. A haptic track comprises metadata 340 to describe the content of the track, the associated gain value, a mixing weight, body localization information and a reference to haptic device specification (defined at the perception level). The track finally contains a list of haptic bands 351, 35N, each band defining a subset of the signal within a given frequency range. For example, the haptic band 351 may correspond to the range of frequencies from 0 to 50 Hz while the haptic band 35N may correspond to the range of frequencies over 2 kHz. A haptic band comprises band data 360 to describe the frequency range of the band, the type of encoding modality (Vectorial or Wavelet), the type of band (Transient, Curve and Wave) and optionally the type of curve (Cubic, Linear or unknown) or the window length. A haptic band is defined by a list of haptic effects 371, 37N. Finally, a haptic effect comprises a list of keyframes 391, 39N and effect data 380, a keyframe being defined by a position (i.e., a temporal reference) and an amplitude. The effect data describes the type of base signal selected amongst Sine, Square, Triangle, SawToothUp, and SawToothDown as well as provide temporal references such as timestamps. The low-level haptic signal can then be reconstructed by combining the keyframes of the haptic effects in the different bands, as illustrated in the example of FIG. 3.

FIG. 4 illustrates an example of signal coded using two haptic bands. With this technique, a low-level haptic signal is encoded using a two frequency bands, a low frequency band 410 and a high frequency band 420, each of them defining a part of the signal in a given frequency range. In this example, the low frequency band corresponds to frequencies below 72.5 Hz Hz while the high frequency band corresponds to frequencies equal to or higher than 72.5 Hz. On the rendering side, the device combines the two parts together (i.e., adding them together) to generate the final haptic signal 440.

The data for a frequency band may be reconstructed based on keyframes and according to a type of haptic band selected amongst Transient, Curve and Wave bands. Additionally, for Wave bands, two types of encoding modalities can be used: Vectorial or Wavelet. Each band is composed of a series of Effects and each Effect is defined by a list of Keyframes that are represented as dots in the figure. The data contained in the effects and keyframes is interpreted differently for different types of haptic bands and encoding modalities.

For a Transient band, each effect stores a set of keyframes defining a position, an amplitude, and a frequency. A keyframe represents a transient event. The signal may be reconstructed using the type of periodic base signal specified in the effect metadata with the amplitude specified in the keyframe and the period given by the frequency of the keyframe. A transient event is a very short signal generated for a few periods only. The number of generated periods is determined by the decoder.

For a Curve band, each effect stores a set of keyframes defining a position (i.e., a temporal reference) and an amplitude. The keyframes represent control points of a curve and an interpolation is performed to generate the curve from the control points. The type of interpolation function is either cubic or linear and is specified in the metadata of the band (380 in FIG. 3). The signal may be reconstructed by performing an interpolation between the amplitudes of keyframes according to their temporal references.

For Vectorial Wave bands, the effect stores a set of keyframes defining a position (i.e., a temporal reference), an amplitude and a frequency. In this case, the signal is generated using the type of periodic base signal specified in the effect metadata with the amplitude specified in the keyframe and the period given by the frequency of the keyframe. The SPIHT wavelet encoding scheme (http://www.siliconimaging.com/SPIHT.htm) may be used for the Wavelet band or types of wavelet encoding. For example, for the Wavelet band, the effect may store the contents of one wavelet block. It contains a keyframe for every coefficient of the wavelet transformed and quantized signal, indicating the amplitude value of the wavelet. The coefficients are scaled to a range of [−1,1]. Additionally, the original maximum amplitude is stored in a keyframe, as well as the maximum number of used bits. In this case, the signal may be reconstructed using the coefficients to perform an inverse wavelet transform.

The frequency band decomposition may use a Low Pass Filter and a High pass filter to split the signal into a low frequency band and a high frequency band. The two bands are then processed differently. Various methods can be used for the encoding of the high frequency part. A first solution is to split the high frequency signal into smaller fixed length windows and use Short-time Fourier Transform (STFT) to decompose the signal in the frequency spectrum. Another solution is to use wavelet transforms to encode the high frequencies. The data structure illustrated in FIG. 3 allows to define multiple bands with different frequency ranges. These bands are used to store the coefficients of the Fourier or Wavelet Transforms.

For the low frequency part of the signal, the data of this frequency band is stored through a list of keyframe points defined by a timestamp and an amplitude. The data also contains information relative to the type of interpolation used to reproduce the signal of this band. The keyframes (i.e., control points) defining the low frequency band are obtained by simply extracting the local extrema of the low frequency signal.

In the example of the figure, the low frequency band 410 is defined as a Curve band using a single effect 411. Such representation is particularly adapted to the low frequency part of the signal. The effect 411 is defined by the keyframes 4111, 4112, 4113, 4114, 4115, 4116, 4117, 4118, 4119. The signal for the low frequency band is generated by a cubic interpolation between these keyframes. The high frequency band 420 is defined by 4 effects 421, 422, 423, 424. These effects are defined as Vectorial bands. The effect 421 is based on 4 keyframes 4211, 4212, 4213, 4214. The effect 422 is based on 11 keyframes (not numbered on the figure). The effect 423 is based on 2 keyframes 4231 and 4232. The effect 424 is based on 2 keyframes 4241 and 4242.

While the description is based on a set of two bands defining a range for low frequencies and a range for high frequencies, the principles apply also in the case more than two ranges of frequencies are used. In this case, the low frequency band becomes the lowest frequency band and the high frequency band becomes the highest frequency band. The lowest frequency band may for example be encoded using a curve band using a single effect, as represented by the low frequency band 410 of FIG. 4. Other frequency bands may be encoded with any of the other type of encoding, for example using a vectorial wave band based on wavelets, as represented by the high frequency band 420 of FIG. 4 but using multiple instances of encoding, one for each band of frequencies.

One advantage of this solution with regards to the structure is that the signal data is easy to package and particularly convenient for streaming purposes Indeed, with such linear structure, the data can be easily broken down to small consecutive packages and does not require complicated data-pre-fetching operations. The signal is easily reconstructed by patching the packages back together to ensure a smooth playback of the signal. It may also be reconstructed by only taking the low frequency part and reconstruct a lower quality (but potentially sufficient) signal without taking into account the high frequency band.

As detailed in the following section, the further sections of this document describe the encoding of PCM waveform signals, for example carried by input WAV files. In this context, an input WAV file describes a single perception modality and even if the file contains multiple tracks, the encoder will process each track separately. Therefore, for the sake of clarity in the remainder of the disclosure, the description will describe the encoding and decoding of a single track.

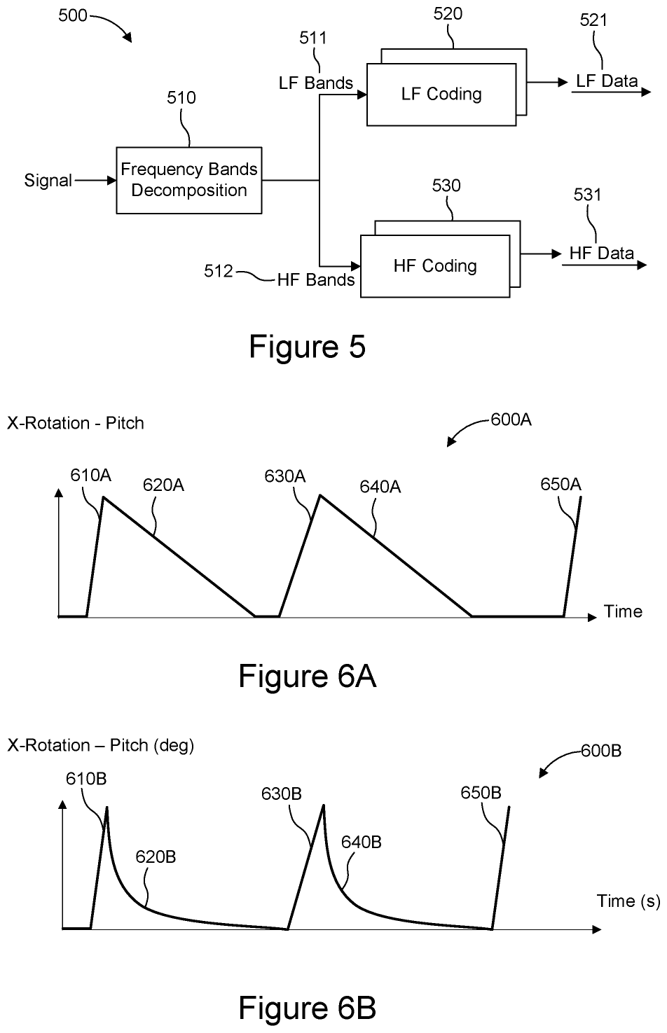

FIG. 5 illustrates the conventional method for encoding a low-level haptic signal in two bands of frequencies. This corresponds to the signal processing step 212 of FIG. 2 and is for example implemented by an encoder such as the immersive scene generator 111 of FIG. 1. Given an input PCM signal, the encoder starts the process 500 by performing a frequency band decomposition. Using a Low Pass Filter and a High pass filter, the encoder splits, in step 510, the signal into low frequency bands 511 and high frequency bands 512. In step 520, the encoder analyses each low frequency bands and extracts data 521 representing the low frequency bands, and in step 530 analyses each high frequency band and extracts data 531 representing the high frequency bands. The extracted data are then formatted according to the structure of FIG. 3 in the formatting step 220 of FIG. 2.

In a typical example implementation, there is a single low frequency band that is encoded using a Curve band, so that the LF data comprises a set of keyframes extracted in step 520 and there is a single high frequency band that is encoded using a vectorial wave band so that the HF data comprises a set of wavelets extracted in step 530, as described above in FIG. 4.

This hybrid format combining Curve bands and Wave bands is interesting and allows to store low frequency signals very easily. This is especially convenient for synthetic signals that were produced through Haptic authoring tools (in particular kinesthetic signals).

As introduced above in FIG. 2, information regarding characteristics of a reference haptic rendering device on which the signal is optimally rendered may be carried by metadata 321 in the data structure presented in FIG. 3. If the haptic rendering device is different from the reference device, the signal may be adapted to better represent the intended effect. Characteristics of the reference device are helpful for this purpose but may not be enough. Indeed, some information concerning the nature of the signal may be missing, especially in the case of kinesthetic devices and motion platforms. Some parts of the signal are not meant to be felt by the user but are aiming at a washout effect, i.e., relocating the device to a neutral position. Indeed, going back to the center of the workspace is necessary to be able to render another effect. If these washout parts of the signal are not identified, the transcoding from one device to another may produce inaccurate results and bad user experience.

FIG. 6A illustrates an example of haptic signal for a motion platform haptic device comprising three forwards effects. Only one degree of freedom is represented in the haptic effect 600A and represents the rotation over the X axis, corresponding to the pitch. The rendering of the effects 610A, 630A, 650A results in rotating the seat backward so that a forward motion effect is felt by the user of the motion platform. In order to render a second effect 630A after a first effect 610A, the device must return towards a neutral (or central) position to prevent the device reaching its maximal capabilities and thus be blocked and unable to render correctly the following effects. For that purpose, in at least one embodiment, washout effects 620A, 640A are signaled to instruct the device to return to a neutral position in order to be ready for the next effect. There is an important difference between a haptic effect and a washout in the sense that a washout should not be felt by the user. Movements of washouts are designed to stay below the perception threshold of the vestibular system (˜3°/s for angular motion). Therefore, the washout part of the haptic signal is generally designed to respect the perception threshold.

FIG. 6B illustrates an example of the adaptation of the haptic signal of FIG. 6A to a force feedback haptic device according to an embodiment. Indeed, rendering the haptic signal of FIG. 6A on a force feedback haptic device needs some adaptation since the perception threshold of the human kinesthetic system is different from the vestibular one. If the signal of FIG. 6A would be provided to a force feedback haptic device directly without any adaptation (or simply rescaled to the workspace of the device), the user would be able feel the device returning back to its neutral position, thus weakening the haptic experience.

In order to provide the full haptic experience without this drawback, the washout must be adapted according to the type of device, the device capabilities and the target body part, so that the haptic effect is fully perceived, and the washout is not perceived. FIG. 6B shows the result of the adaptation of the signal of FIG. 6A into the signal 600B for rendering on a force-feedback device held in the right hand for example. The part of the signal corresponding to the washout effect 602B, 640B is adapted to respect the perception level for the human kinesthetic system while other parts 610B, 630B, 650B are unaltered.

Embodiments described hereafter have been designed with the foregoing in mind and propose to differentiate, within a haptic signal, the part related to the washout from the part related to the haptic effect. This allows a haptic rendering device to adapt the haptic signal to the specific type of haptic device, the haptic device capabilities, and the target body part, in order to remain below the perception threshold and ensure the expected haptic experience.

Embodiments described hereafter propose to provide information for enabling the identification of washout effects in an encoded haptic signal of a MPEG Haptics codec based on the interchange file format describing an immersive scene introduced in FIG. 3. The identification may take the form of a Boolean washout flag in the syntax of the file format.

A first embodiment presents the washout flag at the band level of the data structure of the file format. Indeed, washouts typically use low-frequency signals so that a low-frequency band could be used to carry a washout while high-frequency bands would remain preserved. Therefore, this would lead to a haptic signal combining a curve band identified as a washout and a wave band comprising the haptic effects.

A second embodiment presents the washout flag at the effect level, thus allowing within a same band, to carry both the haptic effects and the washouts.

A third embodiment may use a specific track for carrying only washouts and identify the haptic signal as being a washout through a washout flag. From an authoring point of view, this embodiment is probably the most straight-forward implementation.

For the sake of readability, the description of the embodiments is based on the human readable version (interchange) of the immersive file format. However, the same principles apply to the binary version of the format.

According to the first embodiment, Boolean information (i.e., washout flag) is associated with a haptic band and determines whether the corresponding signal of the haptic band is a washout or not. When the washout flag is “true”, the haptic signal of the haptic band is identified as a washout and needs to be adapted by the rendering device in order to remain below the perception threshold. Any type of band described above (transient, curve or wave) may be used to describe a signal. In this first embodiment, the whole haptic signal of the band is dedicated to washout so that no haptic signal can be carried using this band.

This first embodiment is implemented in an inmmersive scene description (300 in FIG. 3) comprising haptic effects using the “washout” boolean flag of the “Haptics_band” element according to the JSON schema of Table 1.

```
TABLE 1
{
  “$schema” : “http://json-schema.org/draft-04/schema”,
  “title” : “Haptics_band”,
  “type” : “object”,
  “properties” : {
    “band_type”: {
      “type”: “string”,
      “enum”: [“Wave”, “Curve”, “Transient”],
      “description”: “Specifies the type of data contained in the band”
    },
    “encoding_modality”: {
      “type”: “string”,
      “enum”: [“Quantized”, “Vectorial”],
      “description”: “Specifies the encoding modality. The data can be
Quantized or Vectorial”
    },
    “window_length”: {
      “type”: “number”,
      “description”: “Duration of a haptic wave”
    },
    “lower_frequency_limit”: {
      “type”: “number”,
      “description”: “Lower frequency limit of the band”,
      “minimum”: 0.0,
      “maximum”: 1000.0
    },
    “upper_frequency_limit”: {
      “type”: “number”,
      “description”: “Upper frequency limit of the band”,
      “minimum”: 0.0,
      “maximum”: 1000.0
    },
    “streams”: {
      “type”: “array”,
      “description”: “List of streams”,
      “items”: {
        “type”: “object”,
        “$ref”: “Haptics.effects.schema.json”
      },
      “minItems”: 1
    },
    “washout”: {
      “type”: “boolean”,
      “default”: false,
      “description”: “Indicates if the band is a washout band”
    },
  },
  “required”: [
    “band_type”,
    “encoding_modality”,
    “streams”
  ]
}
```

With this information, the presentation engine of the haptic rendering device will be able to perform the correct rendering of the signal corresponding to a washout effect, thus remaining below the perception threshold.

In a streaming application, the haptic rendering device may use this information to request information related to the following effect. Indeed, knowing in advance what is to be rendered may be useful to drive a washout effect. For example, if the following effect does not start at zero, it may not be useful to fully washout an effect to zero since the next starting position requires to move again.

Table 2 illustrates the glTF™ description for the haptic signal representing the first effect 610 and washout 620 elements of the FIG. 6A. The effect 610 is defined in the first band as a regular linear curve. The second band defines a second effect that is identified as being a washout through the value of the washout flag (“washout”: true). This way the haptic renderer is informed that this part is a washout and may be adapted if needed, depending on the type of haptic device, the haptic device capabilities and the target body part.

```
TABLE 2
{
  “avatars”: [ ],
  “date”: “Tue Mar 15 16:52:09 2022\n”,
  “description”: “Washout”,
  “perceptions”: [
    {
    “avatar_id”: 0,
    “description”: “Motion effect”,
    “id”: 0,
      “perception_modality”: “Motion”,
      “reference_devices”: [ ],
                “tracks”: [
                  {
                        “bands”: [
                          {
                                “band_type”: “Curve”,
                                “curve_type”: “Linear”,
                                  “effects”: [
                                        {
                                        “keyframes”: [
                                                  {
                                                  “amplitude_modulation”:0,
                                                  “relative_position”: 0
                                                  }
                                          ],
                                      “phase”: 0.0,
                                      “position”: 0
                                        },
                                      {
                                        “keyframes”: [
                                                  {
                                                  “amplitude_modulation”:1,
                                                  “relative_position”: 0
                                                  }
                                        ],
                                    “phase”: 0.0,
                                    “position”: 10.0
                                    }
                              ],
                      “lower_frequency_limit”: 0,
                      “upper_frequency_limit”: 300,
                    “window_length”: 0
              },
              {
                          “band_type”: “Curve”,
                          “washout”: true,
                          “curve_type”: “Linear”,
                            “effects”: [
                              {
                                          “keyframes”: [
                                            {
                                                    “amplitude_modulation”: 10,
                                                      “relative_position”: 0
                                              }
                                              ],
                                            “phase”: 0.0,
                                            “position” 10.0
                                            },
                                            {
                                          “keyframes”: [
                                            {
                                                        “amplitude_modulation”: 0,
                                                        “relative_position”: 0
                                              }
                                                ],
                                              “phase”: 0.0,
                                              “position”: 30.0
                              }
                          “washout”: true
                        ],
            }
        ],
                      “body_part_mask”: 0xFFFFFFF,
                    “description”: “Full Body”,
                      “gain”: 1.0,
                      “id”: 0,
                      “mixing_weight”: 1.0
          }
    ]
  }
],
“version”: “1”
}
```

A variant of this embodiment comprises using a band type instead of using a Boolean flag to identify a band as a washout band. Since washouts are mainly used for kinesthetic data, the band data can be interpreted like a Curve band or a Transient band. If an effect in the band contains multiple keyframes, it defines a washout Curve and if an effect contains a single keyframe with the starting timestamp of the washout, the rendering of the washout is left to the rendering engine, based on the device capabilities. Table 3 shows the JSON schema for a haptic band according to this variant.

```
TABLE 3
{
  “$schema” : “http://json-schema.org/draft-04/schema”,
  “title” : “Haptics_band”,
  “type” : “object”,
  “properties” : {
    “band_type”: {
      “type”: “string”,
      “enum”: [“Wave”, “Curve”, “Transient”, “Washout”],
      “description”: “Specifies the type of data contained in the band”
    },
    “encoding_modality”: {
      “type”: “string”,
      “enum”: [“Quantized”, “Vectorial”],
      “description”: “Specifies the encoding modality. The data can be
Quantized or Vectorial”
    },
    “window_length”: {
      “type”: “number”,
      “description”: “Duration of a haptic wave”
    },
    “lower_frequency_limit”: {
      “type”: “number”,
      “description”: “Lower frequency limit of the band”,
      “minimum”: 0.0,
      “maximum”: 1000.0
    },
    “upper_frequency_limit”: {
      “type”: “number”,
      “description”: “Upper frequency limit of the band”,
      “minimum”: 0.0,
      “maximum”: 1000.0
    },
    “streams”: {
      “type”: “array”,
      “description”: “List of streams”,
      “items”: {
        “type”: “object”,
        “$ref”: “Haptics.effects.schema.json”
      },
      “minItems”: 1
    },
  },
  “required”: [
    “band_type”,
    “encoding_modality”,
    “streams”
  ]
}
```

According to the second embodiment, Boolean information (i.e., washout flag) is associated with a haptic effect and determines whether the corresponding signal of the haptic effect corresponds to a washout effect or not. Being defined at a lower level than in the first embodiment, this would allow a finer granularity in the definition of the effects.

This second embodiment may be implemented in an immersive scene description (300 in FIG. 3) comprising haptic effects using the “washout” boolean flag of the “Haptics_effect” element according to the JSON schema of Table 4.

```
TABLE 4
{
  “$schema” : “http://json-schema.org/draft-04/schema”,
  “title” : “Haptics_effect”,
  “type” : “object”,
  “properties” : {
      “position”: {
        “type”: “number”,
        “description”: “Temporal position of the effect”,
        “minimum”: 0.0,
      },
      “phase”: {
        “type”: “number”,
        “description”: “Phase of the effect”,
        “minimum”: 0.0,
        “maximum”: 6.28
      },
      “keyframes”: {
        “type”: “array”,
        “description”: “List of keyframes”,
        “items”: {
                “type”: “object”,
                “$ref”: “Haptics.keyframes.schema.json”
        },
        “minItems”: 1
      },
      “base_signal”:{
        “type”: “string”,
        “enum”: [“Sine”, “Square”, “Triangle”, “SawToothUp”,
“SawToothDown”],
        “description”: “Type of the base signal”
      },
      “effect_type”: {
        “type”: “string”,
        “enum”: [“Basis”, “Composite”, “Reference”],
        “description”: “Type of effect: basis, reference or composite”
      },
    ″ Washout”:{
            ″“type″: ″boolean″,
              ″“default”: ″false”,
          “description″:″indicates if the effect is a washout
effect″ }
  },
  “required”: [
      “position”,
      “keyframes”
  ]
}
```

A washout effect can be defined as empty in the sense that only the start position and one end keyframe could be specified. This indicates to the renderer that a washout effect should be performed in between these two points but the way the effect hill be rendered is left to the haptic renderer.

In a variant embodiment, a washout effect is signaled using the existing effect-type property instead of using a separate Boolean property. In Table 5 we provide an example of implementation with an added enumerated value to the existing effect-type property, for example named “Washout”, for signaling that the effect is a washout effect. This solution allows to reuse an existing field and therefore reduces the amount of added data to the immersive scene description file.

```
TABLE 5
{
  “$schema” : “http://json-schema.org/draft-04/schema”,
  “title” : “Haptics_effect”,
  “type” : “object”,
  “properties” : {
    “position”: {
      “type”: “number”,
      “description”: “Temporal position of the effect”,
      “minimum”: 0.0,
    },
    “phase”: {
      “type”: “number”,
      “description”: “Phase of the effect”,
      “minimum”: 0.0,
      “maximum”: 6.28
    },
    “keyframes”: {
      “type”: “array”,
      “description”: “List of keyframes”,
      “items”: {
        “type”: “object”,
        “$ref”: “Haptics.keyframes.schema.json”
      },
      “minItems”: 1
    },
    “base_signal”:{
      “type”: “string”,
      “enum”: [“Sine”, “Square”, “Triangle”, “SawToothUp”,
“SawToothDown”],
      “description”: “Type of the base signal”
    },
    “effect_type”: {
      “type”: “string”,
      “enum”: [“Basis”, “Composite”, “Reference”, “Washout”],
      “description”: “Type of effect: basis, washout”
    },
  },
  “required”: [
    “position”,
    “keyframes”
  ]
}
```

In variant embodiments, additional information on the reference device can be added. A first information that may be added is the workspace center (i.e., the central point targeted by the washout system). Although it is often at [0,0,0] for a 3DoF device, it could also be located elsewhere. This is the case if the workspace is not symmetric or if the device has custom capabilities. A second piece of information that may be added is a maximal speed that the device must not overcome for the washout. It depends on the target body part that is already indicated. In most cases, a washout is performed for a motion or kinesthetic device, but the same principle can be adapted for athermal device. The units for temperature would be ° C./s.

These variant embodiments may be implemented in an immersive scene description (300 in FIG. 3) comprising haptic effects using the ““workspace_center”” element and the “washout_max_speed” element according to the JSON schema of Table 6.

```
TABLE 6
{
  “$schema” : “http://json-schema.org/draft-04/schema”,
  “title” : “Haptics_reference_device”,
  “type” : “object”,
  “allOf”: [ { “$ref”: “glTFProperty.schema.json” } ],
  “properties” : {
    “id”: {
        “type”: “integer”,
        “description”: “Id of the device”
    },
    “name”: {
        “type”: “string”,
        “description”: “Name of the device”
    },
    “body_part_mask”: {
        “type”: “integer”,
        “description”: “Binary mask specifying the location of the device
or actuator on the body”,
        “minimum”: 0,
        “default”: 0
    },
    “maximum_frequency”: {
        “type”: “number”,
        “description”: “Maximum frequency of the actuator”
    },
    “minimum_frequency”: {
        “type”: “number”,
        “description”: “Minimum frequency of the actuator”
    },
    “resonance_frequency”: {
        “type”: “number”,
        “description”: “Resonance frequency of the actuator”
    },
    “maximum_amplitude”: {
        “type”: “number”,
        “description”: “Maximum acceleration of the device. This is also
referred to as the maximum amplitude”
    },
    “impedance”: {
        “type”: “number”,
        “description”: “Impedance of the actuator”,
        “minimum”: 0.0
    },
    “maximum_voltage”: {
        “type”: “number”,
        “description”: “Maximum voltage of the actuator”
    },
    “maximum_current”: {
        “type”: “number”,
        “description”: “Maximum current of the actuator”,
        “minimum”: 0.0
    },
    “maximum_displacement”: {
        “type”: “number”,
        “description”: “Maximum displacement of the actuator (mm)”
    },
    “weight”: {
        “type”: “number”,
        “description”: “Weight of the device”,
        “minimum”: −1.0,
        “maximum”: 1.0
    },
    “size”: {
        “type”: “number”,
        “description”: “Size of the device. Typically, this refers to the
diameter of the actuator.”
    },
    “custom”: {
        “type”: “number”,
        “description”: “Additional custom data.”
    },
    “type”: {
        “type”: “string”,
        “enum”: [“LRA”, “VCA”, “ERM”, “Piezo”],
        “description”: “Type of motor of the actuator”
    },
    “workspace_center”: {
        “type”: “array”,
        “description”: “Zero position of the workspace”,
      “items″ : {
          “type″:“ number″,
          “minimum ”: 0.0
          “maximum ”: 1.0
        }
        “minItems”: 0.0,
        “maxItems”: 6.0,
        “default″ : [0.0, 0.0, 0.0, 0.0, 0.0, 0.0]
    },
    “washout_max_speed”: {
        “type”: “array”,
        “description”: “max speed for each DoF (m/s or deg/s)”,
      “items″ : {
          “type″:“ number″,
          “minimum ”: 0.0
          “maximum ”: 1.0
        }
        “minItems”: 0.0,
        “maxItems”: 6.0,
      “default″ : [0.0, 0.0, 0.0, 0.0, 0.0, 0.0]
    }
  },
  “required”: [
    “device_name”
  ]
}
```

In the MPEG Haptics codec this information related to the workspace center and the maximal washout speed is related to a reference system. Similar information may be available on the rendering side, allowing to perform the adaptation based on the capabilities of the haptic device.

In another variant embodiment, an additional parameter of the washout indicates how much time is available to apply the washout. This may be determined for example according to the subsequent effect.

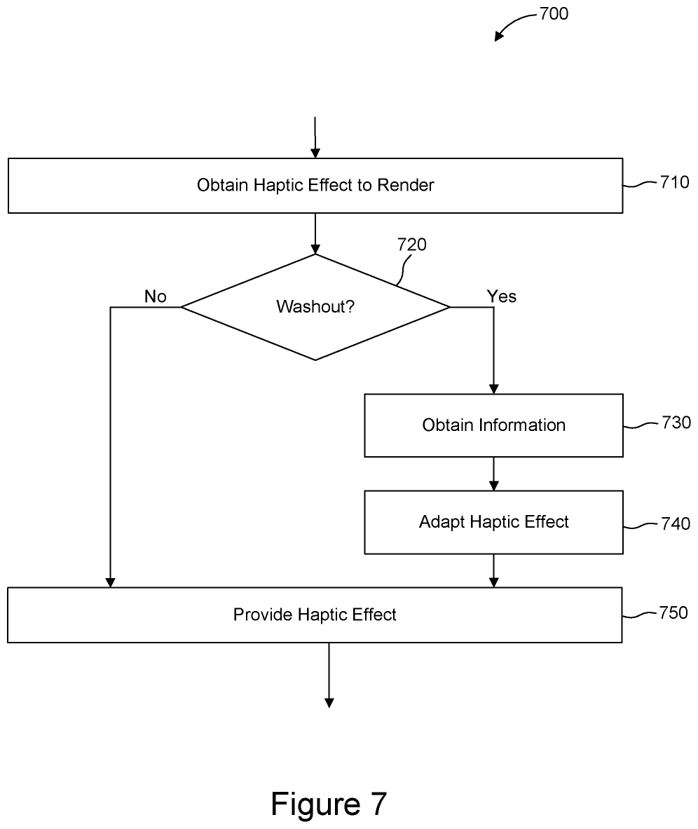

FIG. 7 illustrates an example flowchart of process for rendering a haptic feedback description file according to embodiments. Such process 700 is for example implemented in a haptic rendering device 100 and executed by a processor 101 of such device.

In step 710, the processor obtains a description of an immersive scene (191 in FIG. 1, 301 in FIG. 3). This may be done for example by receiving it from a server through a communication network, by reading it from an external storage device or a local memory, or by any other means. The processor analyses the scene description file in order to extract the haptic object (192 in FIG. 1) that allows to determine the parameters related to the haptic effect to be rendered, comprising more particularly the haptic washout flag associated with a haptic signal.

In step 720, if the haptic washout flag indicates that the corresponding haptic signal is a washout effect, the processor executes the step 730. If it is not the case, it jumps directly to the step 750. As described above, the washout flag may be present at different levels of the immersive scene description, according to the different embodiments based on the tables 1 to 4 using the file format described in FIG. 3.

In step 730, the processor obtains information related to the type of haptic device, the haptic device capabilities, and the target body part where the effect is to be rendered.

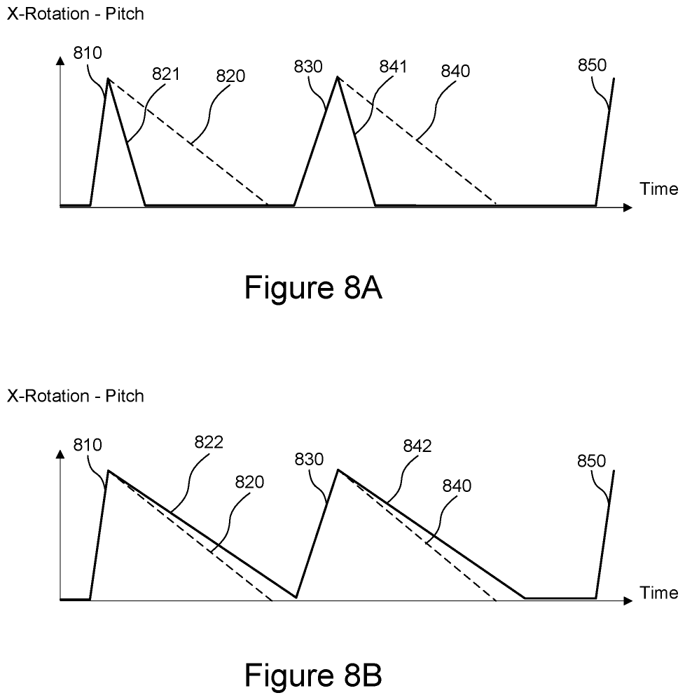

In step 740, the haptic signal is adapted to be rendered as a washout. In other words, the values of the haptic signal are modified to remain below the perception threshold, based on the information obtained in step 730. For instance, the washout effects 620 and 640 described in FIG. 6B were generated for a specific device with a given washout maximum speed. For other devices (for instance different rotating platforms with different center of rotation), the maximum speed that would be unnoticed by the user might be different as shown in FIGS. 8A and 8B.

In step 750, the original haptic signal or the adapted haptic signal is provided to the haptic device for rendering.

Thus, the haptic effect is rendered according to the additional information of the haptic feedback.

FIG. 8A a second example of the adaptation of the haptic signal of FIG. 6A to a force feedback haptic device according to an embodiment. The haptic signal comprises three forward motion effects 810, 830, 850 and two washout effects 820, 840. This example illustrates a situation where the perception threshold is higher than expected so that the washout effects 820 and 840 can be accelerated to be shorter while remaining unnoticed, resulting in the washout effects 821 and 841.

FIG. 8B illustrates a third example of the adaptation of the haptic signal of FIG. 6A to a force feedback haptic device according to an embodiment. Similar to FIG. 8A, the haptic signal comprises three forward motion effects 810, 830, 850 and two washout effects 820, 840. This example illustrates a situation where the perception threshold is lower than expected so that the slope of the washout effects needs to be decreased to remain below the perception threshold, resulting in the washout effects 822 and 842.

These adaptations are typically done at step 740 of the rendering process of FIG. 7 and allow to adapt the washout speed (or slope) according to the rendering capabilities, to ensure a good haptic experience.

Although different embodiments have been described separately, any combination of the embodiments together can be done while respecting the principles of the disclosure.

Although embodiments are related to haptic effects, the person skilled in the art will appreciate that the same principles could apply to other effects such as the sensorial effects for example and thus would comprise smell and taste. The principles may also apply for a geographic position, for example on a virtual reality locomotion platform (e.g., omnidirectional threadmill). Appropriate syntax would thus determine the appropriate parameters related to these effects.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Additionally, this application or its claims may refer to “obtaining” various pieces of information. Obtaining is, as with “accessing”, intended to be a broad term. Obtaining the information may include one or more of, for example, receiving the information, accessing the information, or retrieving the information (for example, from memory or optical media storage). Further, “obtaining” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “AB”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

1. A method comprising:
obtaining haptic data representative of a haptic feedback, the haptic data comprising a haptic signal to render the haptic feedback and information representative of a washout effect for the haptic feedback,
when the information representative of a washout effect for the haptic feedback indicates that the haptic feedback is a washout effect, adapting the haptic signal to remain below a perception threshold, and
providing the adapted haptic signal.

2. The method of claim 1, wherein the haptic signal is carried over frequency bands, a frequency band being represented by haptic data allowing to reconstruct a part of the signal corresponding to a selected range of frequencies, wherein the information representative of a washout effect for the haptic feedback is associated with a frequency band and applies to the associated frequency band.

3. The method of claim 1, wherein the haptic signal is carried over frequency bands, a frequency band being represented by haptic data allowing to reconstruct a part of the signal corresponding to a selected range of frequencies, wherein the part of the signal is further split temporally in a set of haptic effects and wherein information representative of a washout effect for the haptic feedback is associated with a haptic effect and applies to the associated haptic effect.

4. The method of claim 1, wherein the information representative of a washout effect for the haptic feedback is represented by a Boolean flag.

5. The method of claim 1, wherein the information representative of a washout effect for the haptic feedback is represented by an enumerated value.

6. The method of claim 1, wherein the information representative of a washout effect for the haptic feedback is represented using a JSON syntax based on a graphics language transmission format specification.

7. A method comprising:
encoding haptic data representative of a haptic feedback, the haptic data comprising a haptic signal to render the haptic feedback and information representative of a washout effect for the haptic feedback, and
providing the encoded haptic data.

8. The method of claim 7, wherein the haptic signal is carried over frequency bands, a frequency band being represented by haptic data allowing to reconstruct a part of the signal corresponding to a selected range of frequencies, wherein the information representative of a washout effect for the haptic feedback is associated with a frequency band and applies to the associated frequency band.

9. The method of claim 7, wherein the haptic signal is carried over frequency bands, a frequency band being represented by haptic data allowing to reconstruct a part of the signal corresponding to a selected range of frequencies, wherein the part of the signal is further split temporally in a set of haptic effects and wherein information representative of a washout effect for the haptic feedback is associated with a haptic effect and applies to the associated haptic effect.

10. The method of claim 7, wherein the information representative of a washout effect for the haptic feedback is represented by a Boolean flag.

11. The method of claim 7, wherein the information representative of a washout effect for the haptic feedback is represented by an enumerated value.

12. The method of claim 7, wherein the information representative of a washout effect for the haptic feedback is represented using a JSON syntax based on a graphics language transmission format specification.

13. A device comprising a processor configured to:
obtain haptic data representative of a haptic feedback, the haptic data comprising a haptic signal to render the haptic feedback and information representative of a washout effect for the haptic feedback,
when the information representative of a washout effect for the haptic feedback indicates that the haptic feedback is a washout effect, adapt the haptic signal to remain below a perception threshold, and
provide the adapted haptic signal.

14. The device of claim 13, wherein the haptic signal is carried over frequency bands, a frequency band being represented by haptic data allowing to reconstruct a part of the signal corresponding to a selected range of frequencies, wherein the information representative of a washout effect for the haptic feedback is associated with a frequency band and applies to the associated frequency band.

15. The device of claim 13, wherein the haptic signal is carried over frequency bands, a frequency band being represented by haptic data allowing to reconstruct a part of the signal corresponding to a selected range of frequencies, wherein the part of the signal is further split temporally in a set of haptic effects and wherein information representative of a washout effect for the haptic feedback is associated with a haptic effect and applies to the associated haptic effect.

16. The device of claim 13, wherein the information representative of a washout effect for the haptic feedback is represented by a Boolean flag.

17. The device of claim 13, wherein the information representative of a washout effect for the haptic feedback is represented by an enumerated value.

18. The device of claim 13, wherein the information representative of a washout effect for the haptic feedback is represented using a JSON syntax based on a graphics language transmission format specification.

19. A device comprising a processor configured to:
encode haptic data representative of a haptic feedback, the haptic data comprising a haptic signal to render the haptic feedback and information representative of a washout effect for the haptic feedback, and
provide the encoded haptic data.

20-25. (canceled)

26. A non-transitory computer readable medium comprising program code instructions for implementing the method according to claim 1 when executed by a processor.

27-28. (canceled)
